(19) United States
(12) Patent Application Publication
(10) Pub. No.: US 2015/0216357 A1
(43) Pub. Date: Aug. 6, 2015

(54) Microwavable Egg Scrambling Tray

(71) Applicant: Wayne Josephson, Charlottesville, VA (US)

(72) Inventor: Wayne Josephson, Charlottesville, VA (US)

(21) Appl. No.: 14/496,929

(22) Filed: Sep. 25, 2014

Related U.S. Application Data
(60) Provisional application No. 61/936,589, filed on Feb. 6, 2014.

(51) Int. Cl. A47J 36/02; A47J 29/00

(52) U.S. Cl. CPC A47J 36/027; A47J 29/00

(57) ABSTRACT

Described is a microwavable egg scrambling tray. The tray includes one or more rounded depressions in which uncooked eggs and other ingredients can be placed. The depressions have a ridges therein that help to produce light and fluffy scrambled eggs. Preferably the ridges extend from the central, bottom portion of the depression towards the upper edges of the depression. Further, the ridges may be arranged so as to produce a swirled pattern. The ridges help to agitate or aerate the eggs while they are cooking so as to produce light and fluffy eggs of improved consistency. The tray is capable of being microwaved so that scrambled eggs can be quickly prepared. Additionally, the tray is preferably composed of dishwasher safe materials.

### CROSS REFERENCE TO RELATED APPLICATION

This application claims the benefit of U.S. Provisional Application No. 61/936,589 filed on Feb. 6, 2013, entitled “Microwave Egg Scrambler.” The above identified patent application is herein incorporated by reference in its entirety to provide continuity of disclosure.

### BACKGROUND OF THE INVENTION

1. Field of the Invention

The present invention relates to a microwavable egg scrambling device. More specifically, the present invention provides a microwavable tray with one or more hemispherical depressions adapted to receive eggs therein. The depressions include a swirled pattern of ridges therein that facilitates scrambling the eggs to produce light and fluffy scrambled eggs.

Scrambled eggs is a popular breakfast dish that many people enjoy on a regular basis. However, scrambled eggs are commonly prepared in a pan on a stovetop. The user must monitor the eggs as they are cooking, and move the eggs around the pan with a spatula or other utensil to ensure that the eggs cook evenly and do not burn. Thus, cooking scrambled eggs can be time consuming and requires constant attention. Further, preparing scrambled eggs requires the use of a pan and utensil that the user must then clean after preparing the eggs.

The present invention provides a microwavable egg scrambling tray. The device includes a tray having one or more hemispherical depressions therein. The hemispherical depressions are adapted to receive raw eggs and other ingredients therein. Further, the depressions include a plurality of ridges extending from the bottom of the depression towards the upper portion thereof, forming a swirled pattern. The ridges help to agitate and aerate the eggs as they are being cooked in order to produce light and fluffy scrambled eggs. The tray is microwavable and dishwasher safe so that it can be easily cleaned after use.

2. Description of the Prior Art

Devices have been disclosed in the prior art that relate to devices for preparing eggs. These include devices that have been patented and published in patent application publications. These devices generally relate to devices for preparing eggs in a microwave oven. The following is a list of devices deemed most relevant to the present disclosure, which are herein described for the purposes of highlighting and differentiating the unique aspects of the present invention, and further highlighting the drawbacks existing in the prior art.

One such device, U.S. Pat. No. 4,413,167 to Martel et al. discloses a microwave egg cooking device. The device includes a container in which water can be placed, a tray with depressions in which eggs can be placed, and a lid. The water within the container is heated until it boils and the steam heats the tray so that the eggs cook by conduction rather than by microwave radiation. Thus, Martel fails to disclose a device that cooks eggs via microwave radiation and does not disclose a tray having depressions with ridges therein.

U.S. Published Patent Application Number 2006/0029716 to Harker discloses a device for cooking eggs using a microwave. The device is adapted to cook eggs and shape the eggs to match the shape of a piece of bread, such as toast or a bagel, among others. The device includes a tray shaped similarly to a piece of bread, wherein the tray can have a square shape, a circular shape, or an annular shape. A lid is provided that is adapted to fit on any of the trays and that includes ventilation holes thereon. Harker, however, does not disclose a tray having a plurality of depressions with a swirled pattern therein. Thus, Harker discloses a device for preparing scrambled eggs in a desired shape and does not disclose a device for improving the consistency or texture of scrambled eggs prepared in a microwave.

U.S. Pat. No. 5,293,021 to Davis discloses a device for poaching eggs using a microwave. The device includes a container having a base and sidewalls. The base includes a centrally positioned yolk portion. Thus, the yolk of an egg can be positioned and maintained within the central yolk portion and the egg white can flow onto the remainder of the base. Thus, Davis discloses a device for poaching rather than scrambling eggs, and does not include a tray having one or more hemispherical depressions therein.

U.S. Published Patent Application Number 2012/0288593 to Halpern discloses a device for cooking eggs in a microwave. The device comprises a disposable container having a bottom and sidewalls. The container may have a square or circular shape among others. A detachable lid is provided that covers the top portion of the container. Thus, Halpern fails to disclose a tray having depressions therein in which eggs can be positioned for scrambling in a microwave.

Finally, U.S. Pat. No. 4,280,032 to Levinson discloses a device for preparing eggs in a microwave. The device includes a container that is composed of a microwave shielding material. An egg can be positioned within the container for cooking. The container includes a microwave permeable lid and the container is nested within a microwave permeable container. The microwave permeable container can have a liquid placed therein. Thus, Levinson fails to disclose a tray having depression therein in which eggs can be positioned for scrambling.

These prior art devices have several known drawbacks. The devices in the prior art relate to various devices for preparing eggs in a microwave. Some devices use the microwave to heat water to produce steam for use in cooking the eggs in a container. Other devices simply include containers in which eggs can be positioned for exposure to microwave radiation. These devices are not constructed so as to improve the consistency or texture of the eggs, and simply include containers that can be heated in order to cook the eggs.

In light of the devices disclosed in the prior art, it is submitted that the present invention substantially diverges in design elements from the prior art and consequently it is clear that there is a need in the art for an improvement to existing microwavable egg cooking devices. In this regard the instant invention substantially fulfills these needs.

### SUMMARY OF THE INVENTION

In view of the foregoing disadvantages inherent in the known types of microwavable egg cooking devices now present in the prior art, the present invention provides a new microwavable egg cooking device wherein the same can be utilized for providing convenience for the user when preparing scrambled eggs in a microwave oven.

It is therefore an object of the present invention to provide a new and improved microwavable egg cooking device that has all of the advantages of the prior art and none of the disadvantages.

It is another object of the present invention to provide a microwavable egg cooking device comprising a tray with one or more depressions having ridges therein, wherein the ridges may be in a swirled pattern.

Another object of the present invention is to provide a microwavable egg cooking device that produces scrambled eggs of a light and fluffy consistency.

Yet another object of the present invention is to provide a microwavable egg cooking device that is composed of microwave-safe and dishwasher-safe materials.

Another object of the present invention is to provide a microwavable egg cooking device that can be used to cook multiple servings of scrambled eggs at one time.

Another object of the present invention is to provide a microwavable egg cooking device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the microwavable egg scrambling tray of the present invention.

FIG. 2 shows a close-up view of a depression of the microwavable egg scrambling tray of the present invention.

FIG. 3 shows a perspective view of the microwavable egg scrambling tray of the present invention in use with a container.

### DETAILED DESCRIPTION OF THE INVENTION

Reference is made herein to the attached drawings. Like reference numerals are used throughout the drawings to depict like or similar elements of the microwavable egg scrambling device of the present invention. For the purposes of presenting a brief and clear description of the present invention, the preferred embodiment will be discussed as used for preparing scrambled eggs of a light and fluffy consistency in a microwave oven. The figures are intended for representative purposes only and should not be considered to be limiting in any respect.

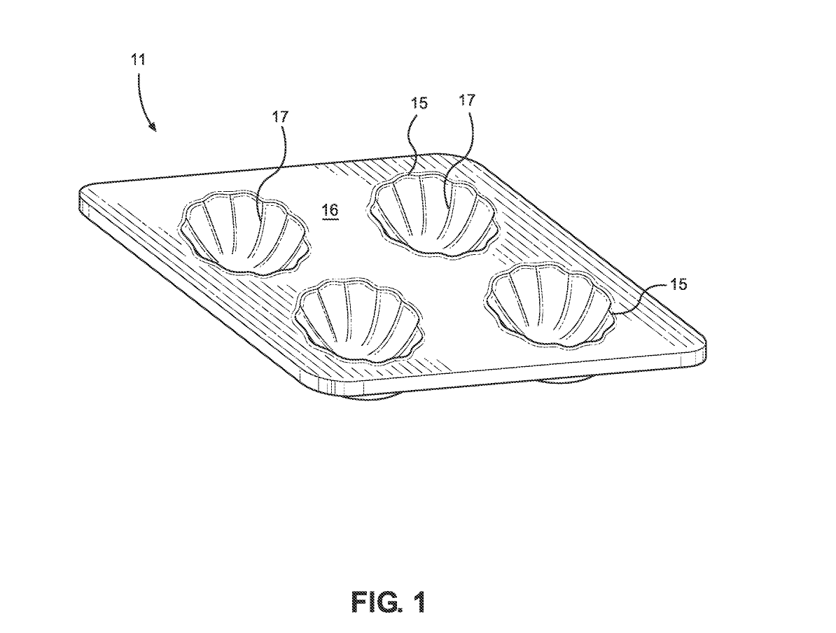

Referring now to FIG. 1, there is shown a perspective view of the microwavable egg scrambling device of the present invention. The egg scrambling device of the present invention includes a tray 11 having an upper surface 16 that is substantially flat and includes at least one depression 15 thereon. Each depression 15 comprises a concave shape, so that the depression 15 extends below the upper surface 16 of the tray 11. Each of the depressions 15 is adapted to receive uncooked eggs and other ingredients therein. The depressions 15 have a circular opening and are rounded. In a preferred embodiment, the depressions 15 have a substantially hemispherical configuration. Further, the depressions 15 include a plurality of ridges 17 therein. Preferably, each of the depressions 15 is substantially identical in shape and size.

In the illustrated embodiment, the upper surface 16 of the tray 11 includes four depressions 14 arranged in a square shape. In this way, a user may prepare multiple portions of scrambled eggs in order to rapidly prepare multiple servings of scrambled eggs. However, in alternate embodiments, the tray 11 may include more or fewer depressions thereon. Additionally, the tray 11 is shown as having a square shape, but the tray 11 may be provided in various other shapes such as a rectangle or a circle, among others.

The tray 11 is preferably composed of microwave-safe and dishwasher-safe materials, so that it can withstand heat and high water pressure. In this way, the tray 11 can be easily cleaned in a dishwasher after use. Further, the tray 11 may include a non-stick surface so that the scrambled eggs prepared therein can be easily removed. Thus, the tray 11 may be composed of silicone or other similar materials.

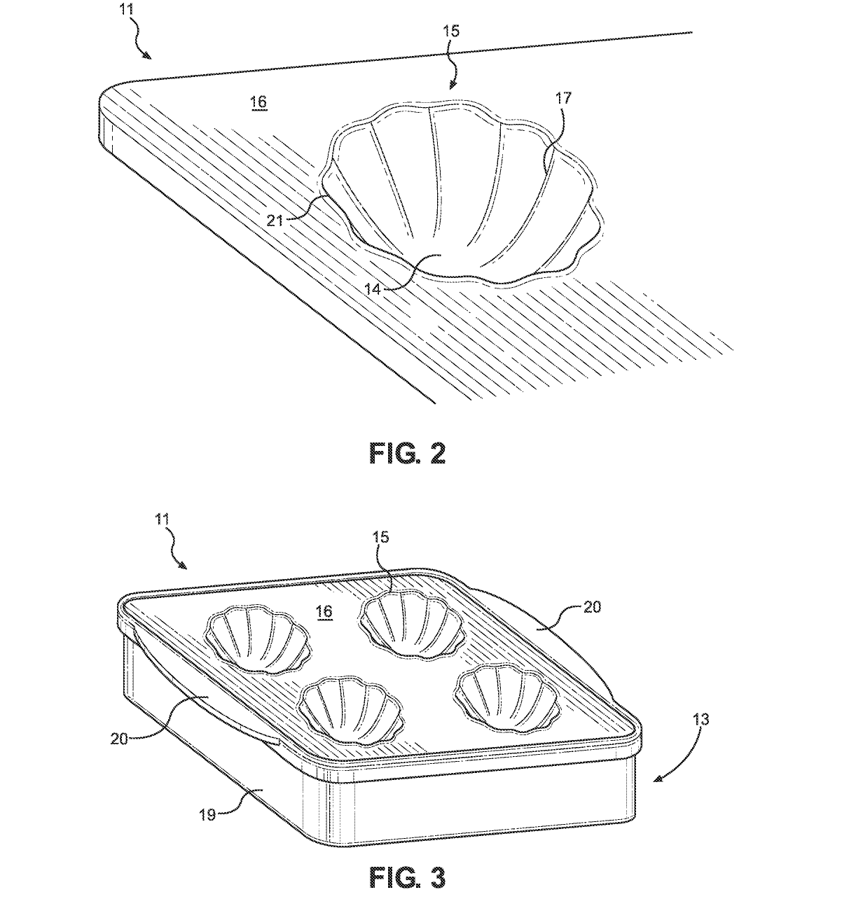

Referring now to FIG. 2, there is shown a close-up view of a depression of the microwavable egg scrambling tray of the present invention. Each depression 15 includes a substantially circular opening 21 on the upper surface 16 of the tray. In some embodiments, the circular opening 21 may have an arcuate or undulating perimeter so that the opening 21 is not perfectly circular.

Further, the depressions 15 includes a plurality of ridges 17 therein. Preferably, the ridges 17 extend from the bottom, central portion 14 of the depression towards the opening 21 or upper end of the depression 15. The ridges 17 are curved or rounded, and do not include any sharp corners or angles. Additionally, the ridges 17 preferably form a swirled pattern centered about the bottom central portion 14 of the depression 15. The ridges 17 facilitate agitation and mixing of the eggs as the eggs cook, helping to incorporate air into the mixture in order to provide a light and fluffy consistency. By promoting agitation of the eggs within the depression 15, the consistency of the eggs is improved and the eggs are allowed to cook evenly. Without the ridges, the eggs may instead have a dense consistency that is unpleasant to the palate. Further, alternate arrangements of ridges 17, such as horizontal or ring shaped ridges, were not found to yield the same improvement in consistency of the cooked eggs.

Referring now to FIG. 3, there is shown a perspective view of the microwavable egg scrambling tray of the present invention in use with a container. In some embodiments of the present invention, the tray 11 is provided within a container 13 that can be used to hold or support the tray 11, and that facilitates carrying the tray 11. The container 13 includes a base having upstanding sidewalls 19 and an open upper end, defining an interior volume. The upper end is adapted to removably receive the tray 11 therein so that the lower surface of the tray 11 is enclosed within the interior volume of the container 13. Opposing sidewalls of the container 13 include outwardly extending tabs 20 thereon that serve as handles for a user to hold. The container 13 is preferably shaped similarly to the tray 11 so that the tray 11 can be positioned therein. It is contemplated that the container 13 and the tray 11 may be rectangular or circular in shape. In the illustrated embodiment, the tray 11 comprises a square shape and is sized so as to fit snugly within the square shaped container 13. Thus, the depressions 15 on the tray 11 may directly contact the base of the container 13. Alternatively, the edges of the tray 11 can rest against the upper end of the container 13, and the depressions 15 can remain elevated above the base of the container 13. The container 13 is preferably composed of a microwave-safe and dishwasher safe material, and may be composed of the same material as the tray 11 of the present invention.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A microwavable egg scrambling device, comprising:
a tray having an upper surface with at least one depression thereon;
wherein said at least one depression includes a plurality of ridges therein.

2. The microwavable egg scrambling device of claim 1, wherein said at least one depression includes a rounded shape.

3. The microwavable egg scrambling device of claim 1, wherein said at least one depression includes a substantially hemispherical shape.

4. The microwavable egg scrambling device of claim 1, wherein said plurality of ridges extend from a bottom of said depression to an upper end of said depression.

5. The microwavable egg scrambling device of claim 1, wherein said plurality of ridges form a swirled pattern.

6. The microwavable egg scrambling device of claim 1, further comprising a container having a base, upstanding sidewalls, and an open upper end;
wherein said container is adapted to removably receive said tray therein.

7. The microwavable egg scrambling device of claim 6, wherein said container includes one or more tabs extending from said sidewalls thereof.

8. The microwavable egg scrambling device of claim 6, wherein said container is substantially square in shape and wherein said tray is substantially square in shape.
